(19) United States
(12) Patent Application Publication
(10) Pub. No.: US 2004/0095772 A1
(43) Pub. Date: May 20, 2004

(54) Outdoor lighting fixture

(75) Inventors: Brandon C. Hoover, Greer, SC (US); James E. Decker, Greenville, SC (US)

Correspondence Address: DORITY & MANNING, P.A., POST OFFICE BOX 1449, GREENVILLE, SC, 29602-1449, US

(73) Assignee: Progress Lighting

(21) Appl. No.: 10/298,265

(22) Filed: Nov. 15, 2002

(51) Int. Cl. F21S 8/00

(52) U.S. Cl. 362/363; 362/431

(57) ABSTRACT

An outdoor lighting fixture that is capable of being mounted flush with a mounting surface is provided. In one embodiment, the outdoor lighting fixture contains a housing having an upper and lower portion. A light source is in operable communication with the housing and can provide light in a direction that is substantially parallel to the mounting surface. It has been discovered that the outdoor lighting fixture of the present invention can be mounted substantially flush with a mounting surface so that it remains relatively hidden from view during use. Furthermore, the outdoor lighting fixture can also provide light in a linear direction, thereby enabling it to illuminate paths, sidewalks, driveways and the like, without having to provide light in all directions.

### BACKGROUND OF THE INVENTION

Landscapers often install a series of outdoor lights along a pathway or other surface for safety and aesthetics. The lights identify and illuminate the pathway while creating a distinctive lighting pattern. Similar lighting is often used to decorative flowerbeds and patio borders, to highlight ponds and garden features, and to otherwise light and decorate residential and commercial grounds as part of the overall landscaping. However, one problem with many conventional outdoor light fixtures is that they are aesthetically unpleasing due their large, bulky shapes. In addition, conventional outdoor light fixtures are often designed in such a manner that light is distributed in virtually every direction, which is often undesired in circumstances that require only minimal lighting.

As such, a need currently exists for an improved outdoor lighting fixture that is relatively hidden from view and that can produce more focused rays of light.

### SUMMARY OF THE INVENTION

In accordance with one embodiment of the present invention, an outdoor lighting fixture is disclosed that comprises a housing containing one or more opaque surfaces that define a light cavity. The housing is configured to be positioned proximate to a mounting surface such that at least a portion of the housing is substantially parallel to the mounting surface. The distance from the mounting surface to the maximum height of the housing when mounted is less than about 3 inches, in some embodiments, less than about 2.75 inches, and in some embodiments, from about 1 to about 2.75 inches.

For example, the housing can have an upper portion and a lower portion having opaque surfaces. If desired, the lower portion may be capable of being positioned proximate to the mounting surface and remaining relatively parallel thereto. Further, the upper portion can define an outer flange that extends beyond the perimeter of the lower portion, wherein the outer flange is also capable of being positioned proximate to the mounting surface and remaining relatively parallel thereto. Generally speaking, the portions of the housing may have any desired shape and/or size. For example, in some embodiments, the upper portion of the housing has a parabolic shape.

A light source is positioned within the light cavity of the housing that is configured to provide light in a direction that is substantially parallel to the mounting surface. For example, in some embodiments, the light source is selected from the group consisting of a halogen lamp, fluorescent lamp, incandescent lamp, and combinations thereof. If desired, the outdoor lighting fixture can further comprise an optical lens that is in communication with the light source to distribute in a pattern light rays produced by said light source. In one embodiment, the housing comprises one or more recessed portions that receive the optical lens.

In accordance with another embodiment of the present invention, an outdoor lighting fixture is disclosed that comprises a housing that contains an upper portion and a lower portion having opaque surfaces that define a light cavity. The housing is configured to be positioned proximate to a mounting surface such that the lower portion is substantially parallel to the mounting surface. The upper portion defines an outer flange that extends beyond the perimeter of the lower portion, wherein the outer flange is also capable of being positioned proximate to the mounting surface and remaining relatively parallel thereto. The outdoor lighting fixture further includes a light source that is positioned within the light cavity and an optical lens in communication with the light source to distribute in a pattern light rays produced by the light source.

In accordance with still another embodiment of the present invention, an outdoor lighting fixture is disclosed that comprises a housing that contains an upper portion and a lower portion having opaque surfaces that define a light cavity. The housing is configured to be positioned proximate to a mounting surface such that the lower portion is substantially parallel to the mounting surface. Further, the upper portion has a parabolic shape. The lighting fixture also comprises a light source that is positioned within the light cavity, the light source being configured to provide light in a direction that is substantially parallel to the mounting surface.

Other features and aspects of the present invention are discussed in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is an illustration of one embodiment of an outdoor lighting fixture of the present invention mounted flush with a mounting surface;

FIG. 2 illustrates one embodiment for assembling an outdoor lighting fixture of the present invention;

FIG. 3 is a perspective view of one embodiment of an outdoor lighting fixture that can be used in the present invention;

FIG. 4 is a side cross-sectional view of one embodiment of the outdoor lighting fixture of the present invention;

FIG. 5 is a top cross-sectional view of one embodiment of the outdoor lighting fixture of the present invention; and

FIG. 6 is a front cross-sectional view of one embodiment of the outdoor lighting fixture of the present invention.

Repeat use of references characters in the present specification and drawings is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention, which broader aspects are embodied in the exemplary construction.

In general, the present invention is directed to an outdoor lighting fixture that is capable of being mounted substantially flush with a mounting surface, such as the ground, paved surface, water, etc. In one embodiment, the outdoor lighting fixture contains a housing having an upper portion and a lower portion. A light source is in operable communication with the housing and can provide light in a direction that is substantially parallel (e.g., horizontal, fan-like distribution) to the mounting surface. It has been discovered that the outdoor lighting fixture of the present invention can be mounted substantially flush with a mounting surface so that it remains relatively hidden from view during use. Furthermore, the outdoor lighting fixture can also provide light in a linear direction, thereby enabling it to illuminate paths, sidewalks, driveways, and the like, without having to provide light in all directions.

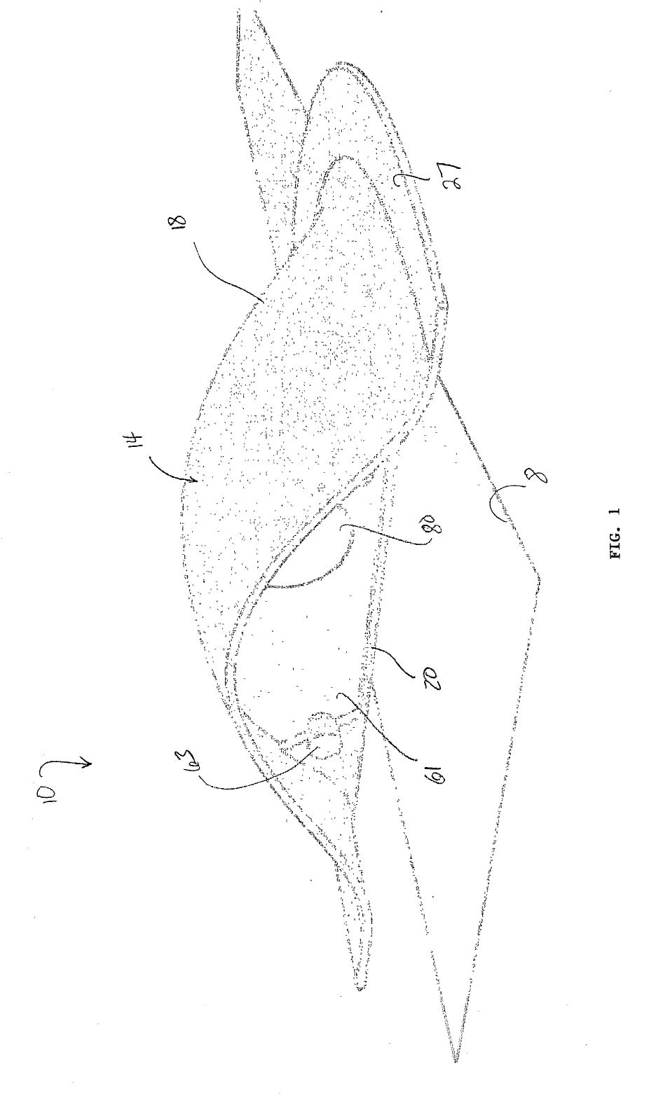

Referring to FIGS. 1-6, for example, one embodiment of an outdoor lighting fixture of the present invention is illustrated. In particular, an outdoor lighting fixture 10 is shown mounted flush with a mounting surface 8. In general, the type of surfaces in which the outdoor lighting fixture of the present invention may be mounted vary greatly depending on the desired application. For example, it is typically desired that the mounting surface 8 constitute the ground so that the outdoor lighting fixture 10 can illuminate pathways, sidewalks, driveways, decks, steps, flowerbeds, patio borders, garden features, ponds, and the like. However, in other embodiments, the mounting surface 8 can be water so that the outdoor lighting fixture 10 can float on the water and thus be positioned substantially flush therewith.

Regardless of the type of mounting surface, the outdoor lighting fixture 10 contains a housing 14 and, optionally, a coupling member 60 and a mounting stake 62. The coupling member 60 can be connected to the bottom of the housing 14, and then attached to a mounting stake 62 to secure the housing 14 to the ground. However, it should be understood that the coupling member 60 and mounting stake 62 are not required in many applications, such as when the housing 14 is laid directly on the mounting surface 8 or when the housing 14 is placed on water.

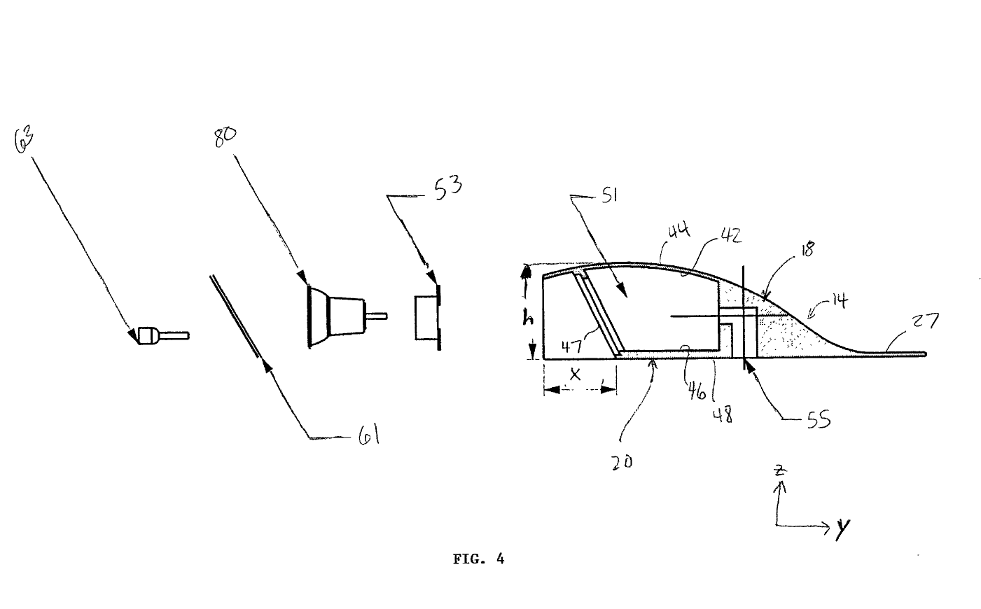

The housing 14 can generally have a variety of different configurations. For instance, as shown in FIGS. 1-6, the housing 14 can include an upper portion 18 and a lower portion 20 which have surfaces that are opaque to light to inhibit the amount of illumination provided in direction perpendicular to the mounting surface 8. As shown in FIG. 4, for instance, the upper portion 18 has an interior surface 42 and an exterior surface 44 and the lower portion 20 has an interior surface 46 and an exterior surface 48.

The overall size of the housing 14 can vary depending on the type of outdoor lighting fixture 10 desired. In most applications, the maximum distance “h” (See FIG. 4) from the lower portion 20 to the upper portion 18 will be less than about 3 inches, in some embodiments less than about 2.75 inches, and in some embodiments, from about 1 inch to about 2.75 inches. In one particular embodiment, for instance, the distance “h” is 1.25 inches. In another embodiment, the distance “h” is 2.625 inches. Similarly, the maximum distance from the upper portion 18 to the mounting surface 8 is also generally less than about 3 inches, in some embodiments less than about 2.75 inches, and in some embodiments, from about 1 inch to about 2.75 inches. It should be understood, however, that the maximum distance “h” may vary slightly from the maximum distance from the upper portion 18 to the mounting surface 8, such as when the housing 14 is not mounted directly on the mounting surface 8 but in close proximity thereto.

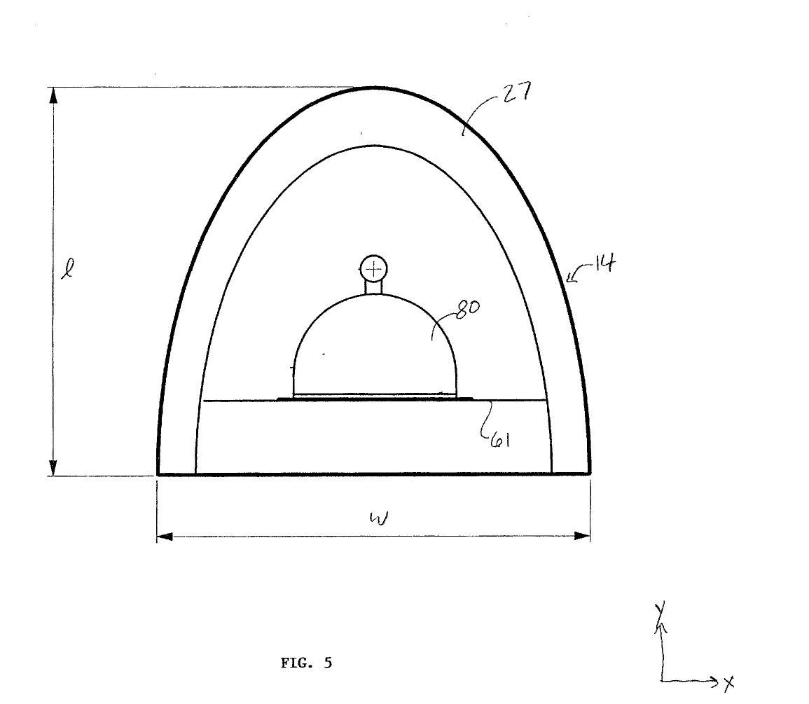

Further, the length and width of the housing 14 can also be varied. For example, in some embodiments, the length “l” of the housing 14 (See FIG. 5) can range from about 2 inches to about 10 inches, and in some embodiments, from about 5 inches to about 8 inches. In one particular embodiment, for example, the length “l” is 6 inches. Moreover, in some embodiments, the housing 14 can also have a width “w” (See FIG. 5) of from about 2 inches to about 10 inches, and in some embodiments, from about 6 inches to about 9 inches. In one particular embodiment, for example, the width “w” of the housing 14 is 6.825 inches. Although not required, a housing having relatively small dimensions, such as a small distance “h”, can provide an outdoor lighting fixture 10 that will be less visible to a user when illuminated, and thus more aesthetically-appealing.

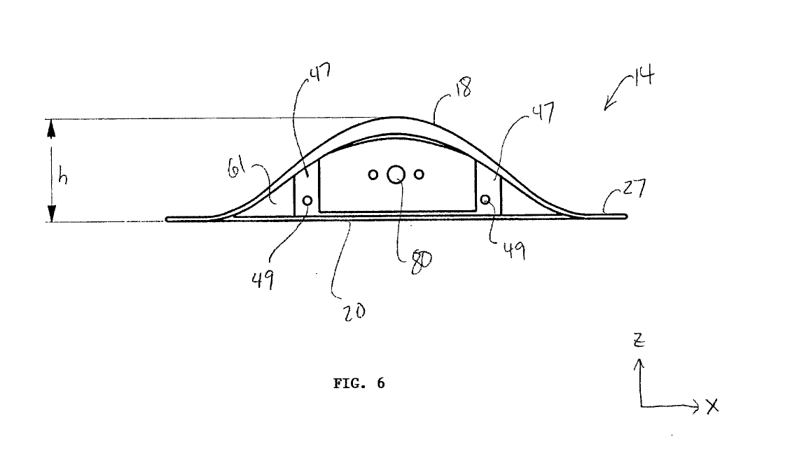

Moreover, the housing 14 can also have a variety of different shapes. For instance, in the illustrated embodiment, the lower portion 20 is substantially flat in the -z direction and has a partially elliptical shape in the x-y plane (FIG. 5). Likewise, the upper portion 18 has a parabolic shape in the x-z plane (FIG. 6) and a partially elliptical shape in the x-y plane. Such a parabolic configuration is achieved, in this embodiment, through the use of an outer flange 27 defined by the upper portion 18. As shown, the outer flange 27 is substantially flat in the -z direction and thus can remain relatively parallel and substantially flush to the mounting surface 8 when positioned proximate thereto. Furthermore, by remaining substantially flat, heat generated by the light source 80 can be more readily dissipated from the interior of the housing 12.

Besides having a parabolic shape, other curved shapes may also be used, e.g., oval, elliptical, circular, irregular curves, etc. Although not required, a “curved” housing shape can further facilitate the dissipation of heat generated by the light source 80, and can also provide a more aesthetically appealing design to a user. However, it should be understood that a curved housing shape is not required in the present invention, and that virtually any shape can be used to form the housing 14. For instance, other examples of suitable shapes for the housing 14 include, but are not limited to, square, rectangular, triangular, circular, oval, trapezoidal, irregular shapes, and the like.

The housing 14 may generally be formed from a variety of different materials. For instance, in some embodiments, a metallic material, such as aluminum, bronze, brass, etc. may be used to form the housing 14. It should be understood that other materials, such as plastics, may also be used in the present invention. Regardless of the particular material used to form the housing 14, it is sometimes desired that a reflective substance, such as white paint, be coated onto one or more surfaces of the housing 14 to reflect the light rays generated by a light source 80. For instance, the interior surfaces 42 and/or 46 may be coated with a reflective substance to enhance the ability of the housing 14 to provide illumination in the desired directions. If desired, the coating may also be placed on other surfaces of the housing 14.

The light source 80 can generally be any type of light or lamp well known in the art, including, but not limited to, halogen lamps, fluorescent lamps, incandescent lamps, and the like. For example, in one embodiment, the light source 80 includes a low-voltage (e.g., 12 volts) halogen lamp having a power of less than about 50 watts, in some embodiments less than about 35 watts, and in some embodiments, from about 25 watts to about 35 watts. In one particular embodiment, an MR 8 Low Voltage Housing Lamp, which is available from Ushio America, Inc. of Cypress, Calif., can be used in the present invention as the light source 80. The MR 8 lamp has a 1-inch diameter and includes a parabolic housing to enhance light dissipation.

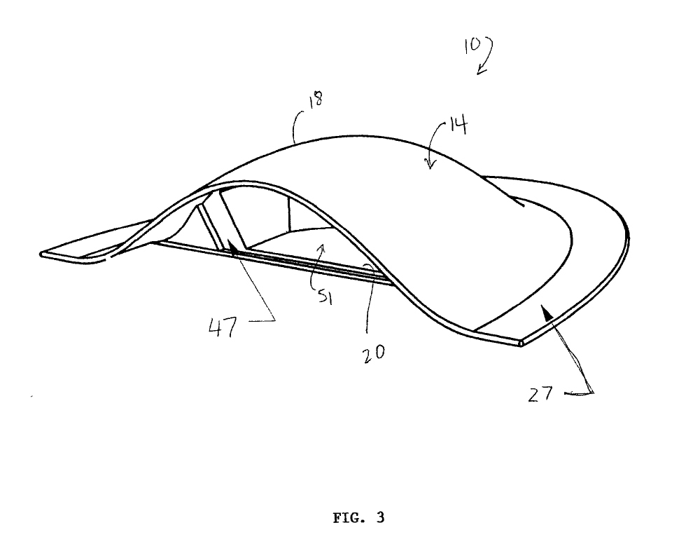

As shown in FIGS. 3-4, the light source 80 may be installed within a light source cavity 51 defined by the interior surfaces of portions 18 and 20. For example, in one embodiment, a bi-pin socket 53 is connected to an opening 55 using a treaded connector (not shown), such as a ⅛ inch NPS (National Pipe Straight) or NPT (National Pipe Taper) threaded connector. In this embodiment, the light source 80 may then be positioned within the socket 53.

If desired, an optical lens 61 that directs light in a certain pattern may be used. The lens 61 can be formed of a transparent material, such as glass, and can allow a portion of the light beam from the light source 80 to pass therethrough, as is conventional in such light fixtures. The optical lens 61 may be selected to have any particular shape so that a multiplicity of direct (down-lighting), indirect (up-lighting) or outward lighting patterns may be produced, such as through prisms or ridges that produce a preselected light pattern. In one embodiment, the lens 61 is a generally flat lens. Alternatively, a lens 61 having a convex portion can also be utilized. Regardless, the optical lens 61 cooperates with the housing 14 and the light source 80 to produce a light pattern that is substantially parallel to the mounting surface 8.

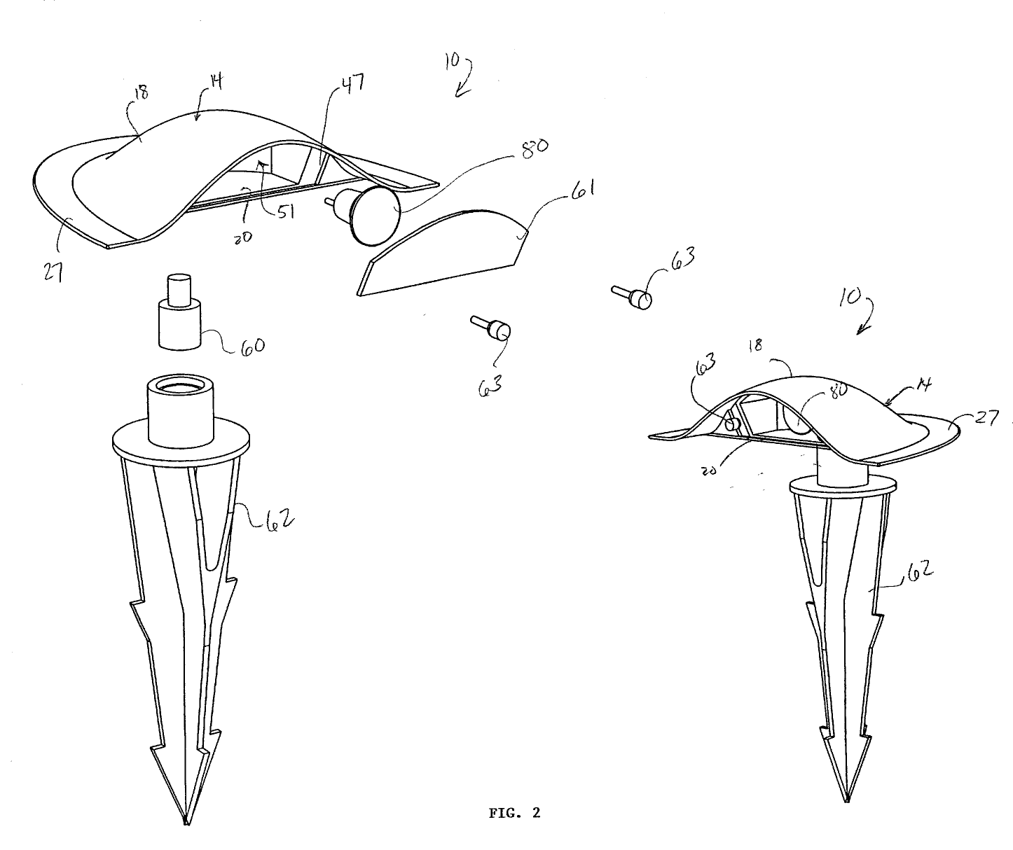

To connect the optical lens 61 to the housing 14, a variety of techniques may be utilized. For example, in one embodiment, such as shown in FIGS. 2-4 and 6, the housing 14 is equipped with one or more recessed portions 47 capable of accepting the optical lens 61. In the illustrated embodiment, for instance, one or more surfaces of the lens 61 can be recessed a distance “x” (FIG. 4) from the front face of the housing 14. In some embodiments, the distance “x” can be less than about 5 inches, in some embodiments from about 1 to about 5 inches, and in some embodiments, from about 1 to about 2 inches. The optical lens 61 can be mounted by inserting one or more fastening devices 63 (e.g., screws) through holes 49 that align with similar holes in the recessed portions 47. As a result, the lens 61 can cover the light source cavity 51 to seal it to the housing 14. In another embodiment, a retaining outer ring may be used with fastening devices to claim the lens 61 into place in the recessed portions 47. Gaskets or sealants may also be used to waterproof the light source cavity 51.

As a result of the present invention, it has been discovered that the outdoor lighting fixture can be mounted substantially flush with a mounting surface so that it remains relatively hidden from view during use. The ability of the fixture to remain hidden can be enhanced by minimizing the distance from the mounting surface to the maximum height of the housing. For example, in some embodiments, the distance from the mounting surface to the maximum height of the housing is less than about 3 inches, in some embodiments, less than about 2.75 inches, and in some embodiments, from about 1 to about 2.75 inches. Furthermore, the outdoor lighting fixture can also provide light in substantially a linear direction, thereby enabling it to illuminate paths, sidewalks, driveways, and the like, without having to provide light in all directions. Such linear illumination can be enhanced by utilizing a housing having opaque surfaces and by enhancing the reflectivity of the inner cavity using, for instance, reflective paint, optical lenses, and the like. Further, the shape of the housing (e.g., parabolic) can also enhance the ability of the lighting fixture to provide light in a linear direction, while remaining relatively hidden from view.

These and other modifications and variations of the present invention may be practiced by those of ordinary skill in the art, without departing from the spirit and scope of the present invention. In addition, it should be understood that aspects of the various embodiments may be interchanged either in whole or in part. Furthermore, those of ordinary skill in the art will appreciate that the foregoing description is by way of example only, and is not intended to limit the invention so further described in such appended claims.

What is claimed is:

1. An outdoor lighting fixture comprising:
a housing that contains one or more opaque surfaces that define a light cavity, said housing being configured to be positioned proximate to a mounting surface such that at least a portion of said housing is substantially parallel to said mounting surface, wherein the distance from said mounting surface to the maximum height of said housing when mounted is less than about 3 inches; and
a light source that is positioned within said light cavity, said light source being configured to provide light in a direction that is substantially parallel to the mounting surface.

2. An outdoor lighting fixture as defined in claim 1, wherein the distance from said mounting surface to the maximum height of said housing when mounted is less than about 2.75 inches.

3. An outdoor lighting fixture as defined in claim 1, wherein the distance from said mounting surface to the maximum height of said housing when mounted is from about 1 to about 2.75 inches.

4. An outdoor lighting fixture as defined in claim 1, wherein said housing has an upper portion and a lower portion that define said opaque surfaces.

5. An outdoor lighting fixture as defined in claim 4, wherein said lower portion is capable of being positioned proximate to said mounting surface and remaining relatively parallel thereto.

6. An outdoor lighting fixture as defined in claim 5, wherein said upper portion defines an outer flange that extends beyond the perimeter of said lower portion, wherein said outer flange is also capable of being positioned proximate to said mounting surface and remaining relatively parallel thereto.

7. An outdoor lighting fixture as defined in claim 4, where said upper portion has a parabolic shape.

8. An outdoor lighting fixture as defined in claim 1, wherein said housing is formed from a metallic material.

9. An outdoor lighting fixture as defined in claim 1, wherein said housing has an exterior surface and an interior surface, wherein at least a portion of said interior surface is coated with a reflective substance.

10. An outdoor lighting fixture as defined in claim 1, further comprising an optical lens that is in communication with said light source to distribute in a pattern light rays produced by said light source.

11. An outdoor lighting fixture as defined in claim 10, wherein said housing comprises one or more recessed portions that receive said optical lens.

12. An outdoor lighting fixture as defined in claim 1, wherein said light source is selected from the group consisting of a halogen lamp, fluorescent lamp, incandescent lamp, and combinations thereof.

13. An outdoor lighting fixture comprising:
a housing that contains an upper portion and a lower portion having opaque surfaces that define a light cavity, said housing being configured to be positioned proximate to a mounting surface such that said lower portion is substantially parallel to said mounting surface, wherein the distance from said mounting surface to the maximum height of said housing when mounted is less than about 3 inches; and
a light source that is positioned within said light cavity, said light source being configured to provide light in a direction that is substantially parallel to the mounting surface.

14. An outdoor lighting fixture as defined in claim 13, wherein the distance from said mounting surface to the maximum height of said housing when mounted is less than about 2.75 inches.

15. An outdoor lighting fixture as defined in claim 13, wherein the distance from said mounting surface to the maximum height of said housing when mounted is from about 1 to about 2.75 inches.

16. An outdoor lighting fixture as defined in claim 13, wherein said upper portion defines an outer flange that extends beyond the perimeter of said lower portion, wherein said outer flange is also capable of being positioned proximate to said mounting surface and remaining relatively parallel thereto.

17. An outdoor lighting fixture as defined in claim 13, where said upper portion has a parabolic shape.

18. An outdoor lighting fixture as defined in claim 13, further comprising an optical lens that is in communication with said light source to distribute in a pattern light rays produced by said light source.

19. An outdoor lighting fixture comprising:
a housing that contains an upper portion and a lower portion having opaque surfaces that define a light cavity, said housing being configured to be positioned proximate to a mounting surface such that said lower portion is substantially parallel to said mounting surface, said upper portion defining an outer flange that extends beyond the perimeter of said lower portion, wherein said outer flange is also capable of being positioned proximate to said mounting surface and remaining relatively parallel thereto;
a light source that is positioned within said light cavity, said light source being configured to provide light in a direction that is substantially parallel to the mounting surface; and
an optical lens in communication with said light source to distribute in a pattern light rays produced by said light source.

20. An outdoor lighting fixture as defined in claim 19, wherein the distance from said mounting surface to the maximum height of said housing when mounted is less than about 3 inches.

21. An outdoor lighting fixture as defined in claim 19, wherein the distance from said mounting surface to the maximum height of said housing when mounted is less than about 2.75 inches.

22. An outdoor lighting fixture as defined in claim 19, wherein the distance from said mounting surface to the maximum height of said housing when mounted is from about 1 to about 2.75 inches.

23. An outdoor lighting fixture as defined in claim 19, where said upper portion has a parabolic shape.

24. An outdoor lighting fixture comprising:
a housing that contains an upper portion and a lower portion having opaque surfaces that define a light cavity, said housing being configured to be positioned proximate to a mounting surface such that said lower portion is substantially parallel to said mounting surface, said upper portion having a parabolic shape; and
a light source that is positioned within said light cavity, said light source being configured to provide light in a direction that is substantially parallel to the mounting surface.

25. An outdoor lighting fixture as defined in claim 24, wherein said outer portion defines an outer flange that extends beyond the perimeter of said lower portion, wherein said outer flange is also capable of being positioned on said mounting surface and remaining relatively parallel thereto.

26. An outdoor lighting fixture as defined in claim 24, wherein the distance from said mounting surface to the maximum height of said housing when mounted is less than about 3 inches.

27. An outdoor lighting fixture as defined in claim 24, wherein the distance from said mounting surface to the maximum height of said housing when mounted is less than about 2.75 inches.

28. An outdoor lighting fixture as defined in claim 24, wherein the distance from said mounting surface to the maximum height of said housing when mounted is from about 1 to about 2.75 inches.

29. An outdoor lighting fixture as defined in claim 24, further comprising an optical lens in communication with said light source to distribute in a pattern light rays produced by said light source.
